(19) United States
(12) Patent Application Publication
(10) Pub. No.: US 2022/0266106 A1
(43) Pub. Date: Aug. 25, 2022

(54) GAMING PADDLE PROTECTOR SHIELD AND METHOD OF MAKING THE SAME

(71) Applicant: Preston Nygren, Springville, UT (US)

(72) Inventor: Preston Nygren, Springville, UT (US)

(21) Appl. No.: 17/181,711

(22) Filed: Feb. 22, 2021

(51) Int. Cl. A63B 59/42; B44C 1/10

(52) U.S. Cl. CPC A63B 59/42; B44C 1/105; A63B 67/002

(57) ABSTRACT

A protector shield to be adhered to a head portion of a pickleball or other gaming paddle is formed of a sheet of vinyl material having an adhesive on a first surface thereof and having a shape and surface area corresponding with a shape and surface area of a head portion of a pickleball paddle, a graphic design printed on a second surface of the sheet of vinyl material and a laminate formed over the second surface of the sheet of vinyl material to cover and protect the graphic design.

### STATEMENT REGARDING FEDERALLY SPONSORED RESEARCH OR DEVELOPMENT

Not applicable.

COPYRIGHT NOTICE

A portion of this disclosure contains material which is subject to copyright protector. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### Field of the Invention

The present inventive concept relates to a gaming paddle protector shield that can be adhered to a head portion of a factory manufactured gaming paddle, such as a pickleball paddle. The gaming paddle protector shield can be manufactured from a thin layer of a vinyl material that is cut to the same shape as a head portion of a gaming paddle to be adhered thereto to protect the gaming paddle head portion from wear and damage.

The present inventive concept also relates to a gaming paddle protector shield that can include graphic designs thereon, thus providing graphic images to a head portion of a gaming paddle when adhered thereto. These gaming paddle protector shields are provided with an adhesive that can be removed from a head portion of a gaming paddle and replaced with a different protector shield having a different graphic design thereon, thus providing the ability to easily change the look of a gaming paddle at any desired time.

The present inventive concept also relates to a method of making a gaming paddle protector shield that can include graphic designs thereon and can protect a gaming paddle from wear and damage.

### DESCRIPTION OF THE RELATED ART

Gaming paddles, such as pickleball paddles and ping pong paddles, are generally made to include a handle portion, a head portion and a neck portion, which connects the handle portion to the head portion. The head portion is generally flat and has a predetermined width and length so as to have a sufficiently wide surface area to be able to easily contact a respective ball to hit the ball across a net during a game. Such gaming ball include, but are not limited to, pickleballs and ping pong balls. As these gaming paddles are continuously used they become dented, scuffed-up and worn down due to the edges thereof contacting surfaces such as, for example, the ground or a table top, as well as other gaming paddles when two players are on a same team when playing a game of doubles. The surfaces of the head portion of these gaming paddles also become worn down and scuffed-up as a result of continuously contacting a respective ball or other objects.

U.S. Patent Publication No. 2018/0104555 A1 by Taylor discusses making a pickleball paddle 20 that produces less sound when striking a ball. More specifically, the paddle 20 by Taylor includes a core 22 with first and second outer faces 24, 26 and a handle 28 extending from the core 22. A sound reducing edge 36 is glued to a core edge 30. On the outer faces 24, 26 are glued first and second skins 32, 34, which overlap the sound reducing edge 36 (see paragraph 0038). Also described at paragraph 0038 is the addition of ears or flanges 58, 60 which are bonded over the first and second skins 32, 34 in order to protect the skins 32, 34. The sound reducing edge 36, first and second skins 32, 34 and flanges 58, 60 are required to be glued to the core 22 during the manufacturing of the paddle as necessary parts of the paddle 20.

There is a need for an attachable and detachable protector shield which can be applied to gaming paddles which are manufactured without a protective covering in order to prevent damage to the gaming paddles during use thereof.

There is also a need for an attachable and detachable protector shield that applies graphic designs onto gaming paddles.

There is also a need for an attachable and detachable protector shield that can be easily attached and detached from a head portion of a gaming paddle so that different graphic designs can be adhered to the gaming paddle, as desired.

### SUMMARY OF THE INVENTIVE CONCEPT

The present general inventive concept provides

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a protector shield for a gaming paddle, including: a sheet of vinyl material including an adhesive formed on a first surface thereof and having a shape and surface area corresponding with a shape and surface area of a gaming paddle head portion of a gaming paddle; a graphic design printed on a second surface of the sheet of vinyl material; and a laminate formed over the second surface of the sheet of vinyl material to cover the graphic design.

In an exemplary embodiment, the shape and surface area thereof can be configured to correspond with the shape and surface area of a pickleball paddle head portion of a pickleball paddle.

In another exemplary embodiment, the shape and surface area thereof are configured to correspond with the shape and surface area of a ping pong paddle head portion of a ping pong paddle.

In another exemplary embodiment, the sheet of vinyl material can be a DPF 4600LX material constructed of a 3.2-mil (80 micron) while gloss high performance calendered film with a tinted, clean removing repositionable adhesive film.

The foregoing and/or other features and utilities of the present general inventive concept may also be achieved by providing a protector shield for a pickleball paddle, including: a DPF 4600LX vinyl film with an adhesive formed on a first surface thereof, the vinyl film having a shape and surface area corresponding with a shape and surface area of a head portion of a pickleball paddle; a graphic design printed on a second surface of the DPF 4600LX vinyl film; and a laminate formed over the second surface of the DPF 4600LX vinyl film to cover the graphic design.

In an exemplary embodiment, the laminate can be a 2-mil (50 micron) cast vinyl film with a clear permanent pressure-sensitive adhesive.

The foregoing and/or other features and utilities of the present general inventive concept may also be achieved by providing a method of making a protector shield for a gaming paddle, the method including: cutting a predetermined size of a vinyl sheet from a vinyl adhesive roll; selecting a graphic design from a plurality of graphic designs programmed into a graphics printer; feeding the vinyl sheet through the graphics printer to print the selected graphic design thereon; feeding the vinyl sheet with the graphic design printed thereon through a laminate machine to apply a laminate over the graphic design; and cutting the vinyl sheet to a shape of a gamming paddle to be adhered thereon.

In an exemplary embodiment, the vinyl adhesive can be formed to approximately 0.35 millimeters in thickness.

In another exemplary embodiment, the laminate can be formed of 2-mil cast vinyl film.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1A illustrates a side view of a gaming paddle protector shield according to an exemplary embodiment of the present inventive concept, as being partially adhered to a pickleball paddle head portion;

FIG. 1B illustrates a sideview of the gaming paddle protector shield according to the exemplary embodiment of the FIG. 1A, as being fully adhered to a pickleball paddle head portion;

FIG. 2 illustrates a front view of the gaming paddle protector shield according to the exemplary embodiment of FIG. 1A, as being partially adhered to a pickleball paddle head portion; and

FIG. 3 illustrates a front view of the gaming paddle protector shield according to the exemplary embodiment of FIG. 1B, as being fully adhered to a pickleball paddle head portion.

The drawings illustrate exemplary embodiments of the present inventive concept, and are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted for brevity of the detailed description of the present inventive concept.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the block may be embodied as hardware or software or embodied by combining hardware and software.

Hereinafter, one or more exemplary embodiments of the present general inventive concept will be described in detail with reference to accompanying drawings.

Exemplary embodiments of the present general inventive concept are directed to a gaming paddle protector shield that can be adhered to a head portion of a factory manufactured gaming paddle. The gaming paddle protector shield can be manufactured from a thin layer of a vinyl material and then cut to the same shape as a head portion of a gaming paddle to be adhered thereto to protect the gaming paddle head portion from wear and damage.

Exemplary embodiments of the present general inventive concept are directed to a gaming paddle protector shield that can include graphic designs thereon, thus providing graphic images to a head portion of a gaming paddle when adhered thereto. These gaming paddle protector shields can be removed from a head portion of a gaming paddle and replaced with a different protector shield having a different graphic design thereon, thus providing the ability to change the look of a gaming paddle at any desired time.

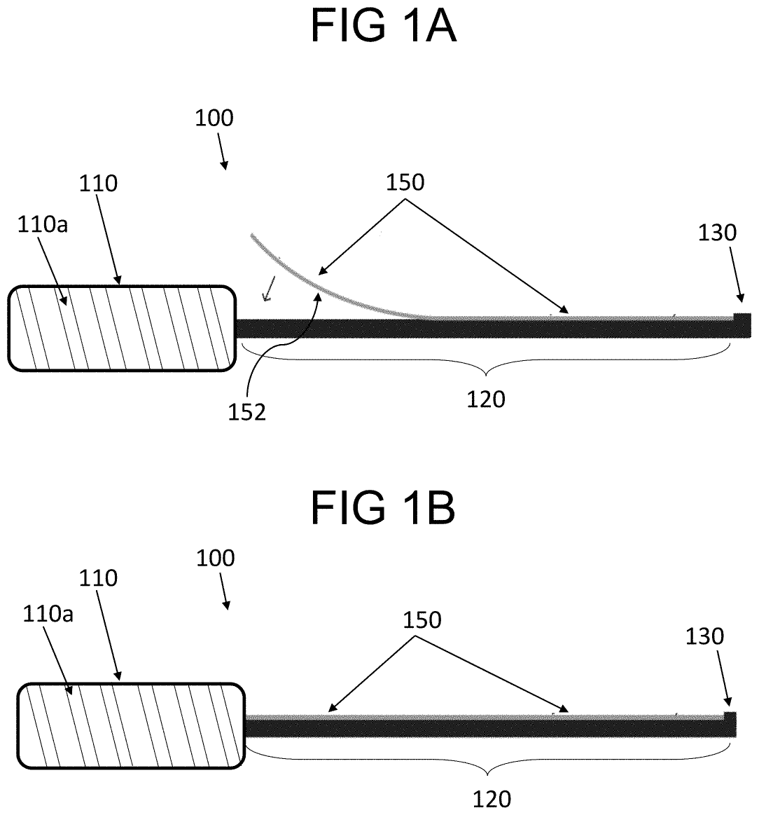

FIG. 1A illustrates a side view of a gaming paddle protector shield 150 according to an exemplary embodiment of the present inventive concept. In FIG. 1A the gaming paddle protector shield 150 is illustrated as being partly adhered to a pickleball paddle head portion 120 of a pickleball paddle 100. According to an exemplary embodiment, the gaming paddle protector shield 150 can include an adhesive 152 provided on a back side thereof to adhere the gaming paddle protector shield 150 to a surface of the head portion 120 of the pickleball paddle 100.

A handle 110 of a pickleball paddle 100 is generally attached to the head portion 120 thereof to allow a user to firmly hold the paddle 100 while playing the game of pickleball. A grip 110a is generally wrapped around the handle 110 to aid the user is maintaining a firm grip on the pickleball paddle 100. The pickleball paddle 100, including the head portion 120, handle 110 and grip 110a are not part of the present inventive concept, but are presented for an understanding of the parts and use of a pickleball paddle 100.

A peelable paper (not illustrated) can be disposed over the adhesive 152 prior to use thereof in order to prevent the adhesive 152 from sticking to objects until a user intends to adhere the gaming paddle protector shield 150 to the surface of a head portion 120 of a pickleball paddle 100 (although the gaming paddle protector shield 150 according to the present inventive concept can be adhered to various gaming paddle head portions to protect the same from damage and wear, the detailed description below will refer to pickleball paddles for brevity of the description).

When the peelable paper (not illustrated) is peeled off the back side of the gaming paddle protector shield 150 where the adhesive 152 is disposed, the adhesive 152 becomes exposed so that the adhesive 152 can be placed in direct contact with a surface of the head portion 120 of a pickleball paddle 100 to adhere the gaming paddle protector shield 150 to the surface of the head portion 120 of the pickleball paddle 100. It is to be noted that although the gaming paddle protector shield 150 is illustrated as being adhered to a front surface F of a head portion 120, the gaming paddle protector shield 150 according the present inventive concept can be adhered to both front F and back B surfaces of the head portion 120 of the pickleball paddle 100.

Since the surface area of different pickleball paddle head portions 120 come in various sizes, the gaming paddle protector shield 150 according to the present inventive concept can be pre-cut to the shape and size of a surface area of any pickleball paddle head portion 120 among the various shapes and sizes of pickleball paddles presently available on the market. It is to be noted that the size of the gaming paddle protector shield 150 can be formed to any present and future size and shape of pickleball paddle head portions 120, as pickleball paddle technology continues to develop.

The gaming paddle protector shield 150 can also be pre-cut to the shape and size of a surface area of any ping pong paddle head portions (not illustrated) as easily as being pre-cut to the shapes and sizes of any pickleball paddle head portions 120, as described above.

FIG. 1B illustrates a sideview of the gaming paddle protector shield 150 according to the exemplary embodiment of the FIG. 1A, while being fully adhered to a pickleball paddle head portion 120 of a pickleball paddle 100. As illustrated, the dimensions of the gaming paddle protector shield 150 are to be determined by an area formed within an edge portion 130 of a pickleball paddle 100. Generally, an edge 130 is formed around the head portion 120 of a pickleball paddle 100 and aids in keeping the head portion 120 flat while preventing warping of the head portion 120. This edge portion 130 generally surrounds and projects outward from the surface of the head portion 120 and acts as a rim around the head portion 120. As such, the gaming paddle protector shield 150 can be pre-cut to fit within the border and directly adjacent to the edge portion 130 throughout the entire circumference of the edge portion 130.

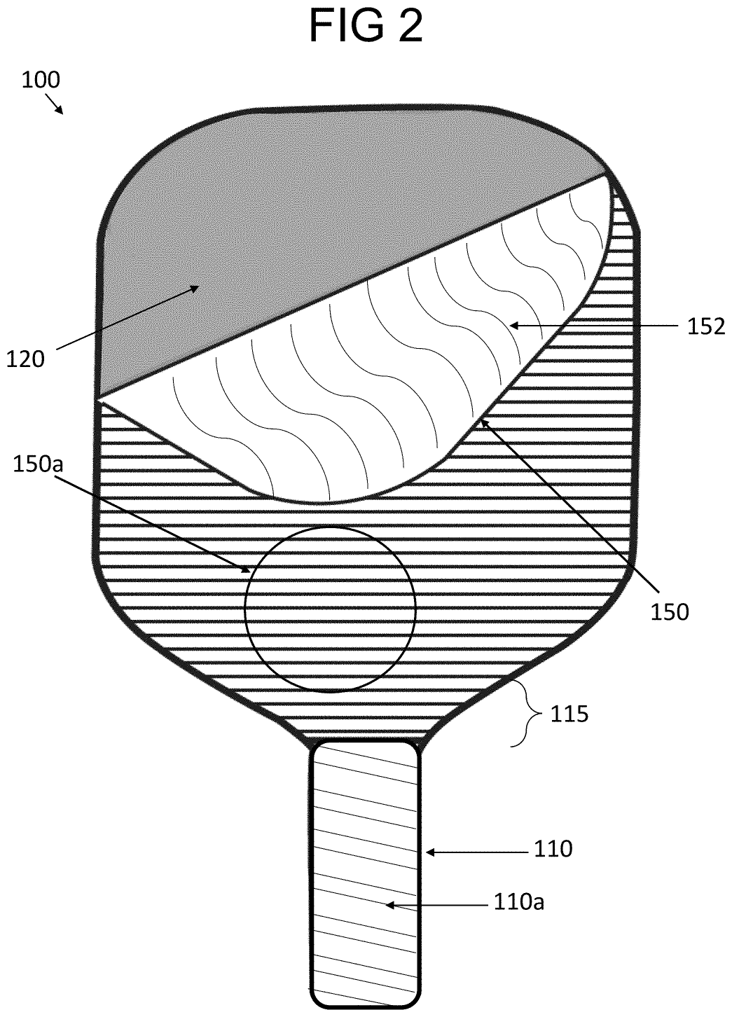

FIG. 2 illustrates a front and partially folded overview of the gaming paddle protector shield 150 according to the exemplary embodiment of FIG. 1A, as the gaming paddle protector shield 150 is partially adhered to the pickleball paddle head portion 120. As illustrated, an adhesive 152 is disposed on one side of the gaming paddle protector shield 150. The adhesive 152 is provided to adhere the gaming paddle protector shield 150 to the front surface F of the pickleball paddle head portion 120, although the gaming paddle protector shield 150 can also be adhered to the back surface B of the pickleball paddle head portion 120.

As illustrated in FIG. 2, edges of the gaming paddle protector shield 150 are positioned to rest directly adjacent to the edge portion 130 of the pickleball paddle 100. Pickleball paddles 100 generally also include a neck portion 115 to transition from the handle 110 to the head portion 120 of the pickleball paddle 100. As such, the gaming paddle protector shield 150 can also be pre-cut to correspond with the shape of the neck portion 115, as illustrated.

Still referring to FIG. 2, a front side of the gaming paddle protector shield 150 can include a graphic design 150a for visual effects. Any of various different graphic designs 150a can be selected by a user (i.e., a purchaser of the gaming paddle protector shield 150) to be printed on the front surface of the gaming paddle protector shield 150 upon purchasing a unique design of the gaming paddle protector shield 150. Alternatively, various graphic designs 150a can be printed on gaming paddle protector shields 150 during the manufacturing thereof and then distributed in large quantities for retail sales at sporting goods stores or via online sales. This graphic design 150a can be printed onto the front surface of the gaming paddle protector shield 150 (the surface opposite the surface in which the adhesive 152 is disposed) with the aid of a graphics printer, as will be described in more detail below.

The adhesive 152 may be of a predetermined bond strength so that the adhesive 152 can be removed from the head portion 120 of a pickleball paddle 100 with a predetermined amount of force. The predetermined bond strength of the adhesive 152 is provided so that a gaming paddle protector shield 150 can be removed from the surface of the head portion 120 of the pickleball paddle 100 in the event that a user thereof desires to replace a graphic design with another graphic design, thus providing the advantage of easily changing the look of a pickleball paddle 100 without having to purchase a new one.

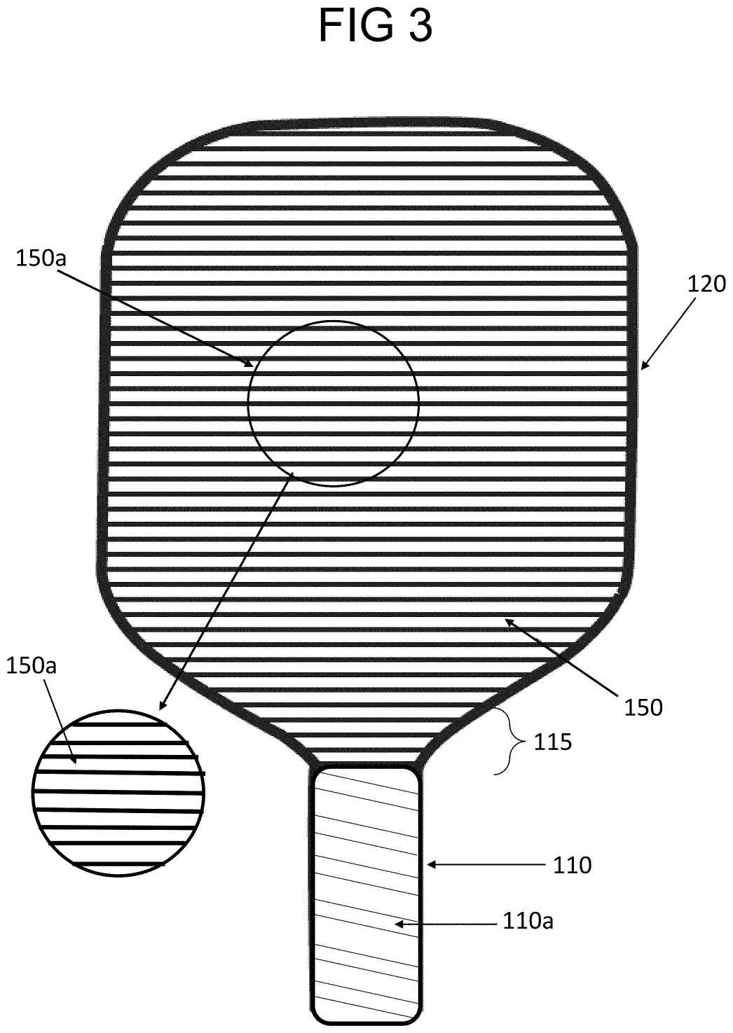

FIG. 3 illustrates a front view of the gaming paddle protector shield 150 according to the exemplary embodiment of FIG. 1B after the entire gaming paddle protector shield 150 is adhered to the pickleball paddle head portion 120. Capitol letter A in FIG. 3 represents an expanded view of one of many graphic designs 150a that can be printed on the front surface of a gaming paddle protector shield 150, according to an exemplary embodiment of the present inventive concept. As discussed above, there are many different graphic designs that can be printed on the front surface of a gaming paddle protector shield 150 according to the present inventive concept. It is to be noted that any number of different designs can be printed onto the gaming paddle protector shield 150 according to the exemplary embodiments of the present inventive concept by programming an industrial printer with the desired design data, as will be described in more detail below.

A process of making the gaming paddle protector shield 150 according to an exemplary embodiment of the present inventive concept is provided below.

Sheets of vinyl material with an adhesive disposed on one side thereof can be formed to a predetermined thickness to be sufficiently flexible for ease of placement on a head portion of a pickleball paddle. An example of the type of vinyl material that can be used is DPF 4600LX (LX=Low Profile) X-Scape Technology constructed of a 3.2-mil (80 micron) white gloss high performance calendered film with a tinted, clean removing, repositionable adhesive system. This repositionable adhesive allows for easy installation while ensuring enough opacity for covering up existing graphics or dark substrates. This vinyl material can be pre-made in large quantities as a vinyl adhesive on rolls.

Next, a printer, such as a HPC latex printer, is be programed with a specific graphic design to be printed on a sheet of vinyl material. Once the printer is programmed to print a specific graphic design, a sheet of the manufactured vinyl is fed through the printer to print the graphic design on a surface opposite the surface in which the adhesive is disposed. After the graphic design is printed on the vinyl material the sheet of vinyl material is fed through a laminating machine to provide the vinyl sheet with a texture to protect the graphic design and to make the sheet of vinyl material stronger. An overlaminate can be constructed of 2-mil (50 micron) cast vinyl film with clear, permanent pressure-sensitive adhesive. This laminate is designed to protect and prolong the life of printed images on the vinyl material as well as to protect objects in which the laminated vinyl shield is adhered to, such as a pickleball paddle head portion 120.

The resultant protector shield 150 according to exemplary embodiments of the present inventive concept is preferably formed to a thickness of 0.35 MM to provide flexibility and ease of placement onto a head portion of a pickleball paddle or other gaming paddle head portions. The thickness of the resultant protector shield 150 can vary as the technology of high performance calendered films and overlaminates changes and advances.

After the vinyl sheet with the graphic design printed thereon is laminated, this vinyl sheet can be cut according to the factory specifications of the paddle in which the vinyl shield is intended to be adhered to, thus creating the protector shield with the same dimensions as the dimensions of the paddle in which the protector shield has been designed. Alternatively, a purchaser of a gaming paddle protector shield 150 according to exemplary embodiments of the present inventive concept can provide the specific details of a pickleball paddle such that a purchased gaming paddle protector shield 150 can be cut to the provided specifications prior to shipping the gaming paddle protector shield 150 to the purchaser.

The completed protector shield is then provided to the purchaser thereof so that the purchaser can adhere the newly manufactured protector shield on his/her paddle.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A protector shield for a gaming paddle, comprising:
a sheet of vinyl material including an adhesive formed on a first surface thereof and having a shape and surface area corresponding with a shape and surface area of a gaming paddle head portion of a gaming paddle;
a graphic design printed on a second surface of the sheet of vinyl material; and
a laminate formed over the second surface of the sheet of vinyl material to cover the graphic design.

2. The protector shield according to claim 1, wherein the shape and surface area thereof are configured to correspond with the shape and surface area of a pickleball paddle head portion of a pickleball paddle.

3. The protector shield according to claim 1, wherein the shape and surface area thereof are configured to correspond with the shape and surface area of a ping pong paddle head portion of a ping pong paddle.

4. The protector shield according to claim 1, wherein sheet of vinyl material is a DPF 4600LX material constructed of a 3.2-mil (80 micron) while gloss high performance calendered film with a tinted, clean removing repositionable adhesive film.

5. A protector shield for a pickleball paddle, comprising:
a DPF 4600LX vinyl film with an adhesive formed on a first surface thereof, the vinyl film having a shape and surface area corresponding with a shape and surface area of a head portion of a pickleball paddle;
a graphic design printed on a second surface of the DPF 4600LX vinyl film; and
a laminate formed over the second surface of the DPF 4600LX vinyl film to cover the graphic design.

6. The protector shield according to claim 5, wherein the laminate is a 2-mil (50 micron) cast vinyl film with a clear permanent pressure-sensitive adhesive.

7. A method of making a protector shield for a gaming paddle, the method comprising:
cutting a predetermined size of a vinyl sheet from a vinyl adhesive roll;
selecting a graphic design from a plurality of graphic designs programmed into a graphics printer;
feeding the vinyl sheet through the graphics printer to print the selected graphic design thereon;
feeding the vinyl sheet with the graphic design printed thereon through a laminate machine to apply a laminate over the graphic design; and
cutting the vinyl sheet to a shape of a gamming paddle to be adhered thereon.

8. The method according to claim 7, wherein the vinyl adhesive is formed to approximately 0.35 millimeters in thickness.

9. The method according to claim 7, wherein the laminate is formed of 2-mil cast vinyl film.
